(19) United States
(12) Patent Application Publication
(10) Pub. No.: US 2025/0333147 A1
(43) Pub. Date: Oct. 30, 2025

(54) METHOD AND DEVICE FOR IMPUTING MISSING VALUES IN DUAL-DIRECTIONAL AIS DATA BASED ON DEEP LEARNING

(71) Applicant: Pusan National University Industry-University Cooperation Foundation, Busan (KR)

(72) Inventors: Hye Rim BAE, Busan (KR); Jae Hyeon HEO, Busan (KR); Ga Won LEE, Busan (KR); Sung Hyun SIM, Busan (KR); Do Hee KIM, Busan (KR)

(21) Appl. No.: 19/190,810

(22) Filed: Apr. 28, 2025

(30) Foreign Application Priority Data
Apr. 30, 2024 (KR) 10-2024-0057371

(51) Int. Cl. B63B 71/10; B63B 79/30; G06N 3/0455

(52) U.S. Cl. CPC B63B 71/10; B63B 79/30; G06N 3/0455

(57) ABSTRACT

A method and device for imputing missing values in dual-directional automatic identification system (AIS) data based on deep learning are provided. The method includes constructing a deep-dual-directional chained imputation (DDDCI) model including a forward model and a backward model and predicting a missing value at a prediction time point t, which is to be imputed for AIS data, by using a forward prediction value predicted through learning by the forward model and a backward prediction value predicted through learning by the backward model.

### CROSS-REFERENCE TO RELATED APPLICATION

This application claims the benefit of Korean Patent Application No. 10-2024-0057371 filed on Apr. 30, 2024, in the Korean Intellectual Property Office, the entire disclosure of which is incorporated herein by reference for all purposes.

### BACKGROUND

### 1. Field of the Invention

This research was supported by Korea Research Institute of Ships and Ocean engineering a grant from Endowment Project of “Development of Open Platform Technologies for Smart Maritime Safety and Industries” funded by Ministry of Oceans and Fisheries (PES5230).

One or more embodiments relate to a method and device for imputing missing values in dual-directional automatic identification system (AIS) data based on deep learning. The device learns movement characteristics of a ship and performs a prediction for a missing value to achieve missing value imputation performance suitable for AIS data, which is collected through an AIS collection device of a ship.

### 2. Description of the Related Art

Korean Registration No. 10-2583270 (Sep. 21, 2023) “Water-environment measurement data management system”

Korean Registration No. 10-2583270 discloses a water environment measurement data management system which collects and purifies various measurement data from water and sewage facilities, separates measurement data and location information of the measurement data and stores them, and can analyze a pattern variation cause based on a pattern of the measurement data.

Korean Registration No. 10-2619131 (Dec. 22, 2023) “Satellite data estimation method and system for missing value”

Korean Registration No. 10-2619131 discloses a method and a system for estimating missing values in satellite data, which can more precisely estimate missing values in satellite data, thereby obtaining more accurate data.

Korean Registration No. 10-2559717 (Jul. 21, 2023) “Apparatus and method for generating 3D human model”

Korean Registration No. 10-2559717 discloses an apparatus and method for generating a 3D human model, which generates a 3D human model by using a light detection and ranging (LiDAR) sensor on a portable device.

Existing automatic identification system (AIS) data missing value imputation technology is a method of filling in missing data in AIS data generated by an AIS collection device and may be categorized into a statistical approach, a geometric approach, and an artificial intelligence (AI)-based approach.

As the statistical approach, examples of hierarchical generative models based on stochastic processes are known. (Üney, Murat, Leonardo M. Millefiori, and Paolo Braca. “Data driven vessel trajectory forecasting using stochastic generative models.” ICASSP 2019-2019 IEEE International Conference on Acoustics, Speech and Signal Processing (ICASSP). IEEE, 2019)

As the geometric approach, examples of spline techniques utilizing dynamic information of ships are known. (Zhang, Daiyong, et al. “Enhance the AIS data availability by screening and interpolation.” 2017 4th International Conference on Transportation Information and Safety (ICTIS). IEEE, 2017)

As the AI-based approaches, studies utilizing a bidirectional long short-term memory (LSTM) model are known. (Yang, Cheng-Hong, et al. “AIS-based intelligent vessel trajectory prediction using bi-LSTM.” IEEE Access 10 (2022): 24302-24315)

Existing AIS data missing value imputation technology has been a separate field from analytics.

In a conventional method of providing AIS data, an entire row of data at the time of a missing point is deleted or only information on a position of a ship is filled in before providing the AIS data.

However, the prior art of AIS data missing value imputation technology has limitations in building and utilizing a model capable of imputing missing points for position information, speed, and heading direction while simultaneously collecting the data.

Thus, there is an urgent need for an improved model that may impute missing values by learning data collected through an AIS collection device of a ship according to a movement of each ship.

### SUMMARY

Embodiments provide a method and device for imputing missing values in dual-directional automatic identification system (AIS) data based on deep learning that has an independent character (e.g., learning weights different for each ship) according to each individual ship (maritime mobile service identity, MMSI) and performs missing value imputation with higher accuracy than conventional methods.

Embodiments provide a method and device for imputing missing values in dual-directional AIS data based on deep learning that achieves missing value imputation performance suitable for AIS data by learning movement characteristics of a ship and performing a prediction for a missing value.

According to an aspect, there is provided a method of imputing missing values in dual-directional AIS data based on deep learning including constructing a deep-dual-directional chained imputation (DDDCI) model including a forward model and a backward model and predicting a missing value at a prediction time point t, which is to be imputed for AIS data, by using a forward prediction value predicted through learning by the forward model and a backward prediction value predicted through learning by the backward model.

According to another aspect, there is provided a device for imputing missing values in dual-directional AIS data based on deep learning including a model construction portion configured to construct a DDDCI model including a forward model and a backward model and a prediction portion configured to predict a missing value at a prediction time point t, which is to be imputed for AIS data, by using a forward prediction value predicted through learning by the forward model and a backward prediction value predicted through learning by the backward model.

Additional aspects of embodiments will be set forth in part in the description which follows and, in part, will be apparent from the description, or may be learned by practice of the disclosure.

According to embodiments, a method and device for imputing missing values in dual-directional AIS data based on deep learning may be provided, which has an independent character (e.g., learning weights different for each ship) according to each individual ship (maritime mobile service identity, MMSI) and performs missing value imputation with higher accuracy than conventional methods.

According to embodiments, a method and device for imputing missing values in dual-directional AIS data based on deep learning may achieve missing value imputation performance suitable for AIS data by learning movement characteristics of a ship and performing a prediction for a missing value.

### BRIEF DESCRIPTION OF THE DRAWINGS

These and/or other aspects, features, and advantages of the invention will become apparent and more readily appreciated from the following description of embodiments, taken in conjunction with the accompanying drawings of which:

FIG. 1 is a block diagram illustrating a configuration of a device for imputing missing values in dual-directional automatic identification system (AIS) data based on deep learning, according to an embodiment;

FIG. 2 is a diagram illustrating a structure of a forward model included in a deep-dual-directional chained imputation (DDDCI) model constructed according to the present disclosure;

FIG. 3 is a diagram illustrating a DDDCI model including a forward model and a backward model;

FIG. 4 is a diagram illustrating an example of outputting, by a DDDCI model according to the present disclosure, a prediction value for AIS data at a desired time point;

FIG. 5 is a diagram illustrating a loss function used in a prediction of AIS data at a time point having no missing point;

FIG. 6 is a diagram illustrating a loss function used in a prediction of AIS data at a time point having a missing point; and

FIG. 7 is a flowchart illustrating a method of imputing missing values in dual-directional AIS data based on deep learning, according to an embodiment.

### DETAILED DESCRIPTION

Hereinafter, embodiments are described in detail with reference to the accompanying drawings. However, various alterations and modifications may be made to the embodiments. Here, the embodiments are not meant to be limiting the scope of rights of the present disclosure. The embodiments should be understood to include all changes, equivalents, and replacements within the idea and the technical scope of the disclosure.

The terminology used herein is for the purpose of describing particular examples only and is not intended to limit the embodiments. The singular forms “a,” “an,” and “the” are intended to include the plural forms as well, unless the context clearly indicates otherwise. It should be further understood that the terms “comprises/comprising” and/or “includes/including,” when used herein, specify the presence of stated features, integers, steps, operations, elements, and/or components, but do not preclude the presence or addition of one or more other features, integers, steps, operations, elements, components and/or groups thereof.

Unless otherwise defined, all terms including technical or scientific terms used herein have the same meaning as those commonly understood by one of ordinary skill in the art to which the embodiments belong. Terms, such as those defined in commonly used dictionaries, are to be interpreted as having a meaning that is consistent with their meaning in the context of the relevant art and the present disclosure, and are not to be interpreted in an idealized or overly formal sense unless expressly so defined herein.

When describing the embodiments with reference to the accompanying drawings, like reference numerals refer to like components and a repeated description related thereto is omitted. In the description of embodiments, detailed description of well-known related structures or functions is omitted when it is deemed that such description may cause ambiguous interpretation of the present disclosure.

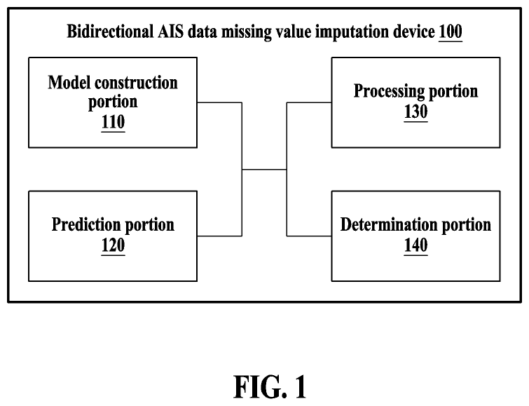

FIG. 1 is a block diagram illustrating a configuration of a device for imputing missing values in dual-directional automatic identification system (AIS) data based on deep learning, according to an embodiment.

Referring to FIG. 1, a device for imputing missing values in dual-directional AIS data based on deep learning according to an embodiment of the present disclosure (hereinafter referred to as “dual-directional AIS data missing value imputation device”) 100 may be configured to include a model construction portion 110 and a prediction portion 120. The dual-directional AIS data missing value imputation device 100 may be configured to optionally include a processing portion 130 and a determination portion 140.

First, the model construction portion 110 may construct a deep-dual-directional chained imputation (DDDCI) model including a forward model and a backward model. That is, the model construction portion 110 may construct the DDDCI model that has a pair of a forward model, which learns a trend in a forward direction, and a backward model, which learns a trend in a reverse direction, wherein the trend is of AIS data at a time point to perform a prediction.

When constructing the DDDCI model, the model construction portion 110 may produce a forward model and a backward model, each having a structure including an encoder and a decoder.

Specifically, the model construction portion 110 may construct the forward model that includes an encoder including at least N gated recurrent units (GRUs) and a decoder disposed on a rear end of the encoder and including one GRU.

Here, N may be a number of pieces of second AIS data collected at a time point prior to a prediction time point t and selected to participate in learning.

That is, the model construction portion 110 may construct the forward model by including an encoder which includes at least N GRUs for training by inputting N pieces of second AIS data up to a time point t-N prior to the time point t to perform a prediction and a decoder which includes 1 GRU for training by inputting an output value of the encoder.

Here, the GRU is one of recurrent neural network (RNN) techniques and may be a simplified model of long short-term memory (LSTM).

For example, the model construction portion 110 may configure the encoder by selecting four time points (e.g., t−4, t−3, t−2, and t−1) prior to the prediction time point t and including at least four GRUs that receive, as an input, each of the second AIS data collected through an AIS collection device at the four selected time points (e.g., t−4, t−3, t−2, and t−1). Alternatively, the model construction portion 110 may configure the encoder including multiple GRUs and activate only four GRUs, according to the number of selected time points, among the multiple GRUs.

In addition, the model construction portion 110 may configure the decoder including one GRU that receives, as an input, an output value of the encoder and first AIS data (which may have a missing point) collected at t.

In summary, when constructing the forward model, the model construction portion 110 may construct the forward model that includes the encoder including at least N GRUs, wherein the N may be a number of pieces of the second AIS data that are input, and the decoder including 1 GRU.

In addition, the model construction portion 110 may construct the backward model, which includes a decoder including one GRU and an encoder disposed on a front end of the decoder and including at least N GRUs.

Here, N may be a number of pieces of second AIS data collected at a time point subsequent to the prediction time point t and selected to participate in learning.

That is, the model construction portion 110 may construct the backward model by including an encoder which includes at least N GRUs for training by inputting N pieces of second AIS data up to a time point t+N subsequent to the time point t to perform a prediction and a decoder which includes 1 GRU for training by inputting an output value of the encoder.

For example, the model construction portion 110 may configure the encoder by selecting four time points (e.g., t+1, t+2, t+3, and t+4) subsequent to the prediction time point t and including at least four GRUs that receive, as an input, each of the second AIS data collected through the AIS collection device at the four selected time points (e.g., t+1, t+2, t+3, and t+4). Alternatively, the model construction portion 110 may configure the encoder including multiple GRUs and activate only four GRUs, according to the number of selected time points, among the multiple GRUs.

In addition, the model construction portion 110 may configure the decoder including one GRU that receives, as an input, the output value of the encoder and the first AIS data (which may have a missing point) collected at t.

In summary, when constructing the backward model, the model construction portion 110 may construct the backward model that includes the decoder including one GRU and the encoder including at least N GRUs, wherein the N may be the number of pieces of the second AIS data that are input.

The prediction portion 120 may predict a missing value at a prediction time t, which is to be imputed for AIS data, by using a forward prediction value predicted through learning by the forward model and a backward prediction value predicted through learning by the backward model. That is, the prediction portion 120 may obtain a forward prediction value according to forward trend learning from the forward model and a backward prediction value according to backward trend learning from the backward model, and may predict AIS data at a prediction time point t to perform a prediction by considering the forward prediction value and the backward prediction value.

When outputting the forward prediction value and the backward prediction value, the dual-directional AIS data missing value imputation device 100 may utilize a context vector output from the encoder.

To this end, the dual-directional AIS data missing value imputation device 100 may be configured to optionally include the processing portion 130.

That is, the processing portion 130 may input, to each of the N GRUs in the encoder of the forward model, second AIS data collected at N time points prior to the prediction time point t and perform deep learning to output a context vector from the encoder, and may input, to the decoder, the context vector and first AIS data collected at the prediction time t and perform deep learning to output the forward prediction value from the decoder.

In the above example, the processing portion 130 may input, to each of the four GRUs in the encoder of the forward model, each of the second AIS data collected at four time points (e.g., t−4, t−3, t−2, and t−1) prior to the prediction time point t, so that deep learning may be performed in the four GRUs.

Thereafter, when the context vector is output as a result of deep learning in the encoder, the processing portion 130 may input the context vector and the first AIS data collected at the prediction time t to the decoder of the forward model, so that deep learning may be performed in one GRU, and consequently, the forward prediction value may be output from the decoder.

In addition, the processing portion 130 may input, to each of the N GRUs in the encoder of the backward model, second AIS data collected at N time points subsequent to the prediction time point t and perform deep learning to output a context vector from the encoder, and may input, to the decoder, the context vector and first AIS data collected at the prediction time point t and perform deep learning to output the backward prediction value from the decoder.

In the above example, the processing portion 130 may input, to each of the four GRUs in the encoder of the backward model, each of the second AIS data collected at four time points (e.g., t+1, t+2, t+3, and t+4) subsequent to the prediction time point t, so that deep learning may be performed in the four GRUs.

Thereafter, when the context vector is output as a result of deep learning in the encoder, the processing portion 130 may input the context vector and the first AIS data collected at the prediction time t to the decoder of the backward model, so that deep learning may be performed in one GRU, and consequently, the backward prediction value may be output from the decoder.

In particular, the processing portion 130 may output the context vector through deep learning that reflects a deep learning result derived from a GRU on a preceding end by cascading deep learning results between the N GRUs. That is, the processing portion 130 may induce the context vector output from the encoder to be closer to a more accurate prediction value by training the GRUs in a cascade manner, in which a deep learning result from a GRU disposed at the front is reflected in a GRU disposed at the back to perform deep learning.

The dual-directional AIS data missing value imputation device 100 may recognize which data column is relatively emphasized and deep-learned in a corresponding GRU by calculating an attention score for each GRU.

That is, the processing portion 130 may calculate an attention score that gives a relatively high score to a data column in the second AIS data that has been emphasized and deep-learned during deep learning in the GRU of the encoder.

Here, the data column may be data of the AIS data, in which a missing point mainly occurs, and in the present disclosure, the data column may exemplify a latitude (lat) and a longitude (lon), which are location information of a ship, and a speed (speed over ground, SOG) and a direction (course over ground, COG), which are information on a movement of a ship.

The processing portion 130 may calculate an attention score so that a data column (e.g., lat, lon, SOG, and COG) in the AIS data that was emphasized at each time point during deep learning in a GRU of the encoder may be recognized.

For example, the processing portion 130 may calculate the attention score for the GRU of the encoder, which may receive AIS data at a time point t+1 and perform deep learning, to be relatively high in the SOG item, so that it may be recognizable that the SOG has been emphasized and deep-learned during deep learning in the GRU at the time point t+1.

According to an embodiment, the dual-directional AIS data missing value imputation device 100 may define a loss of a DDDCI model by satisfying a function that is applied differently depending on whether the first AIS data collected at the prediction time point t includes a missing point.

To this end, the dual-directional AIS data missing value imputation device 100 may be configured with the determination portion 140 added.

First, when there is no missing point in the first AIS data, the dual-directional AIS data missing value imputation device 100 may define the loss of the DDDCI model by using a difference between the predicted AIS data and actually measured first AIS data and may reflect the defined loss in the forward model and the backward model, thereby increasing an accuracy of the predicted value.

Specifically, the determination portion 140 may determine whether there is a missing point in first AIS data collected at the prediction time point t.

For example, for AIS data including data columns (e.g., lat, lon, SOG, COG, cos_COG, and sin_COG), the determination portion 140 may determine whether there is any missing point in the data columns.

When there is no missing point according to a result of the determination, the processing portion 130 may define a loss of the DDDCI model by satisfying Equation 1, which calculates a difference between an actual value (label) of the first AIS data and each of the forward prediction value and the backward prediction value through mean absolute error (MAE).

$${ℒ}_{real} = MAE ( {x}_{pred ,}^{forw} {x}_{real} ) + MAE ( {x}_{pred ,}^{back} {x}_{real} ) \qquad [ Equation 1 ]$$

For a loss at a time point with no missing point, the processing portion 130 may perform learning so that the model may make an accurate prediction by reflecting characteristics of the AIS data through an actual value.

On the other hand, when there is a missing point in the first AIS data collected at the prediction time t, the dual-directional AIS data missing value imputation device 100 may define a loss for imputing the missing point of the first AIS data through the predicted AIS data.

Specifically, when there is a missing point according to a result of the determination, there may be no actual value (or label) of the first AIS data, and thus, the processing portion 130 may define a loss of the DDDCI model by satisfying Equation 2, which calculates only a difference between the forward prediction value and the backward prediction value through MAE.

$${ℒ}_{impute} = λ \times MAE ( {x}_{pred ,}^{forw} {x}_{pred}^{back} ) \qquad [ Equation 2 ]$$

The processing portion 130 may learn the model so that an error of the prediction values in each direction may be small, so that the prediction values may converge as the forward model and the backward model progress learning from different directions at a time point when there is a missing point.

According to an embodiment, a method and device for imputing missing values in dual-directional AIS data based on deep learning may be provided, which has an independent character (e.g., learning weights different for each ship) according to each individual ship (maritime mobile service identity, MMSI) and performs missing value imputation with higher accuracy than conventional methods.

In addition, according to an embodiment of the present disclosure, the method and device may achieve missing value imputation performance suitable for AIS data by learning movement characteristics of a ship and performing a prediction for a missing value.

The dual-directional AIS data missing value imputation device 100 of the present disclosure may use AIS data collected through an AIS collection device of a ship as target data.

The dual-directional AIS data missing value imputation device 100 may use data columns included in the AIS data, which includes a collection time (timestamp), an identifier (e.g., MMSI) for a ship in which a missing value has occurred, the latitude (lat) and the longitude (lon), which are the location information of the ship, and the speed (SOG) and the direction (COG, Course Over Ground), which are the information on a movement of the ship, which are included in the AIS data.

Table 1 lists examples of the AIS data, which is the target data.

TABLE 1

| timestamp | mmsi | lat | lon | SOG | COG |
|---|---|---|---|---|---|
| 2021 Jan. 4 01:20:54 | 44068610 | 34.943893333 | 128.84731833 | 7.3 | 89.9 |
| 2021 Jan. 4 02:09:14 | 44065890 | 34.455116666 | 128.52677666 | 5.1 | 268.4 |
| 2021 Jan. 4 02:21:50 | 44330980 | 34.455116666 | 128.52677666 | 7.1 | 345.0 |
| 2021 Jan. 4 02:24:21 | 52610229 | 35.030358333 | 129.03168833 | 6.9 | 342.6 |
| . . . | . . . | . . . | . . . | . . . | . . . |

The dual-directional AIS data missing value imputation device 100 may impute a missing value for the AIS data collected from the AIS collection device.

The dual-directional AIS data missing value imputation device 100 may divide the AIS data based on MMSI, which is an identifier, and may impute a missing value based on a DDDCI model according to data columns (e.g., latitude, longitude, SOG, and COG) in the divided AIS data.

The dual-directional AIS data missing value imputation device 100 may construct a DDDCI model, learn new weights for each identifier (e.g., MMSI) by utilizing the constructed DDDCI model, and learn the movement of each ship to replace missing values.

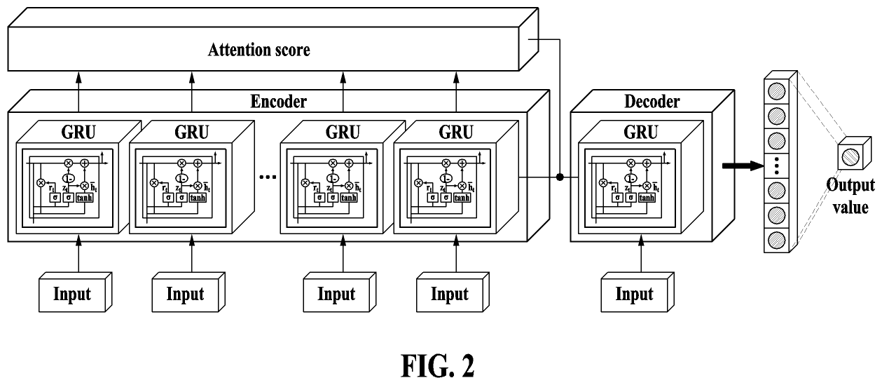

FIG. 2 is a diagram illustrating a structure of a forward model included in a deep-dual-directional chained imputation (DDDCI) model constructed according to the present disclosure.

As shown in FIG. 2, the dual-directional AIS data missing value imputation device 100 may configure a forward model having an encoder including N GRUs and a decoder including one GRU.

The N may be a number of pieces of AIS data selected prior to a time point at which the AIS data is to be predicted.

The GRU is one of RNN techniques and may be a simplified model of LSTM.

For example, in case of predicting AIS data at the prediction time t, the dual-directional AIS data missing value imputation device 100 may select four time points (e.g., t−4, t−3, t−2, and t−1) prior to the time point t and configure an encoder including four GRUs.

Alternatively, the dual-directional AIS data missing value imputation device 100 may configure an encoder including multiple GRUs and activate only four GRUs, according to the number of the selected time points, among the multiple GRUs.

The dual-directional AIS data missing value imputation device 100 may perform deep learning by inputting AIS data (second AIS data) collected at four time points (e.g., t−4, t−3, t−2, and t−1) to each of the four GRUs in the encoder.

Here, the dual-directional AIS data missing value imputation device 100 may calculate an attention score so that a data column (e.g., lat, lon, SOG, and COG) in the AIS data that was emphasized at each time point during deep learning in a GRU of the encoder may be recognized. For example, the dual-directional AIS data missing value imputation device 100 may calculate an attention score for a GRU related to a time point t+1 to be relatively high in the SOG item, so that it may be recognizable that the SOG has been emphasized and deep-learned during deep learning in the GRU at the time point t+1.

Deep learning results may be cascaded between the GRUs in the encoder, and the dual-directional AIS data missing value imputation device 100 may output a context vector from a last GRU in the encoder according to the cascading manner.

The dual-directional AIS data missing value imputation device 100 may input, to the decoder, the context vector of the encoder and the AIS data (first AIS data) collected at t to perform deep learning, and may output an output value from the decoder as a forward prediction value for the AIS data at t through an mlp layer.

The AIS data collected at t, which may be input to the decoder, may or may not include a missing value.

The dual-directional AIS data missing value imputation device 100 may change the loss function of the DDDCI model to be applied, depending on whether a missing value is included.

The encoder of the dual-directional AIS data missing value imputation device 100 may have a Seq2Seq structure and may include a combination of GRUs at each time point, so that an attention mechanism may be utilized to appropriately reflect information at each time point in the model.

The decoder may consist of one GRU and may produce a 256-dimensional vector as an output to derive a prediction value through the mlp layer.

A structure of the backward model may be similar to an overall structure of the forward model of FIG. 2, with only exception of a different direction.

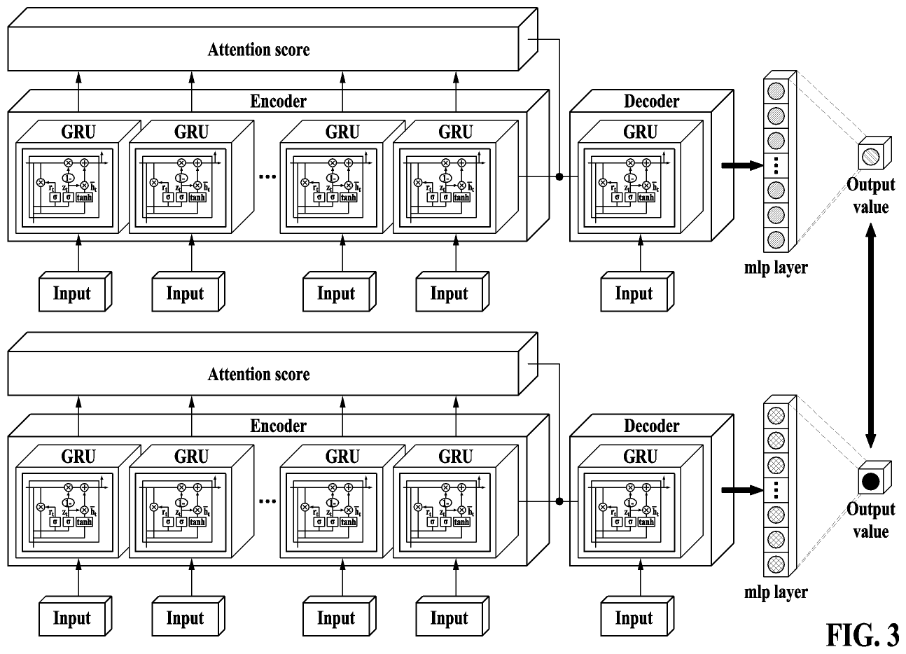

FIG. 3 is a diagram illustrating a DDDCI model including a forward model and a backward model.

The backward model may have a similar structure to the forward model, except for positions of the disposition of an encoder and a decoder.

The DDDCI model may have a structure designed to include a pair of a forward model and a backward model.

As in the above example, when predicting AIS data at t, the dual-directional AIS data missing value imputation device 100 may select four time points (e.g., t+1, t+2, t+3, and t+4) subsequent to t and input, to each of the four GRUs in the encoder, AIS data collected at the four time points (e.g., t+1, t+2, t+3, and t+4) to perform deep learning in the backward model.

Similar to the forward model, the dual-directional AIS data missing value imputation device 100 may produce an attention score for each GRU of the encoder.

Deep learning results may be cascaded between GRUs in the encoder, and the dual-directional AIS data missing value imputation device 100 may output a context vector from a last GRU in the encoder.

The dual-directional AIS data missing value imputation device 100 may input, to the decoder, the context vector of the encoder and the AIS data collected at t to perform deep learning, and may output an output value from the decoder as a backward prediction value for the AIS data at t through an mlp layer.

The DDDCI model of FIG. 3 may be a prediction model having a seq2seq structure consisting of an encoder and a decoder.

The dual-directional AIS data missing value imputation device 100 may extract deep learning results at previous N time points from the encoder through the seq2seq structure of the DDDCI model.

N GRUs may be included in the encoder, and the deep learning results output from the GRUs may be transferred to a GRU at a subsequent time point.

In addition, the dual-directional AIS data missing value imputation device 100 may calculate an attention score at each time point and transmit the attention score to the decoder together with a context vector of the encoder.

The dual-directional AIS data missing value imputation device 100 may perform deep learning on the context vector output from the encoder and AIS data at a current time point by using the GRU of the decoder and may obtain a prediction value (a forward prediction value and a backward prediction value) from the decoder.

The dual-directional AIS data missing value imputation device 100 may learn the DDDCI model by comparing outputs of the forward model and the backward model, respectively.

The loss used in the learning of the DDDCI model may be defined for a point with no missing value and a point with a missing value occurring, respectively.

The dual-directional AIS data missing value imputation 100 may define a loss function to increase prediction accuracy at points in which actual values exist and reduce a difference between the forward model and the backward model.

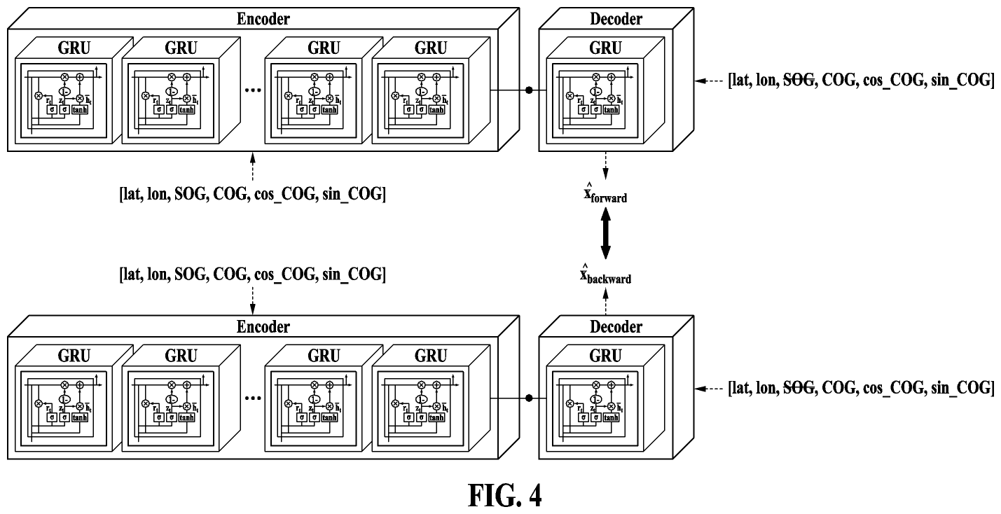

FIG. 4 is a diagram illustrating an example of outputting, by a DDDCI model according to the present disclosure, a prediction value for AIS data at a desired time point.

As shown in FIG. 4, when predicting the AIS data at t, at which a SOG is missing, the dual-directional AIS data missing value imputation device 100 may select four time points (e.g., t−4, t−3, t−2, and t−1) prior to t and input, to each of the four GRUs in the encoder, AIS data collected at the four time points (e.g., t−4, t−3, t−2, and t−1) to perform deep learning.

The AIS data collected at the four time points (e.g., t−4, t−3, t−2, and t−1) that are input to the four GRUs may be normal data without missing data, and cos_COG and sin_COG may be added to the data columns to specify a bearing of a progress direction of a ship, together with lat, lon, SOG, and COG exemplified above.

The dual-directional AIS data missing value imputation device 100 may input, to the decoder, the context vector output from the GRU of t−1 and the AIS data (in which SOG is missing) collected at t to perform deep learning, and output a forward prediction value.

Through a similar process, the dual-directional AIS data missing value imputation device 100 may output backward prediction values related to four time points (e.g., t+1, t+2, t+3, and t+4) subsequent to t.

Thereafter, the dual-directional AIS data missing value imputation device 100 may impute the missing SOG for the AIS data at t by using the forward prediction value output from the forward model and the backward prediction value output from the backward model.

The dual-directional AIS data missing value imputation device 100 of the present disclosure may have unique features in a method of learning the DDDCI model.

Unlike the learning method of a general deep learning model, the dual-directional AIS data missing value imputation device 100 may learn the DDDCI model in a semi-supervised learning method.

The dual-directional AIS data missing value imputation device 100 may apply different loss functions to a part in which a missing point occurs and a part in which no missing point occurs.

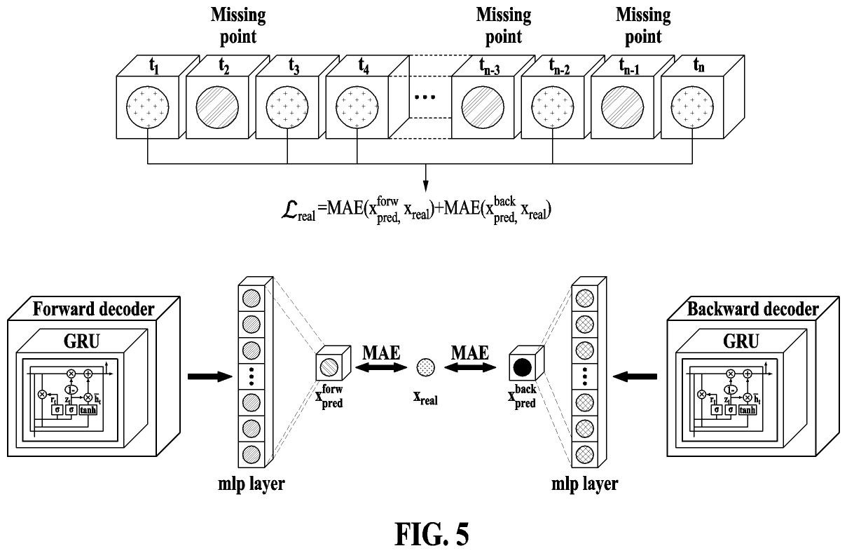

FIG. 5 is a diagram illustrating a loss function used in a prediction of AIS data at a time point having no missing point.

As shown in FIG. 5, at a time point when there is no missing point, the dual-directional AIS data missing value imputation device 100 may define and utilize the loss by satisfying Equation 1, which calculates the difference between the actual value (or label) and each of the forward model and the backward model through MAE.

$${ℒ}_{real} = MAE ( {x}_{pred ,}^{forw} {x}_{real} ) + MAE ( {x}_{pred ,}^{back} {x}_{real} ) \qquad [ Equation 1 ]$$

In Equation 1, the L(real) denotes the loss at a time point when there is an actual value, and the MAE is a formula that is widely used in evaluating a prediction performance of an actual deep learning model and may be a formula that calculates an average value of values obtained by taking an absolute value of a difference between the values in the parentheses.

In addition, the X(forw pred) denotes a prediction value of a forward model, the X(real) denotes an actual value, and the X(back pred) denotes a prediction value of a backward model.

For a loss at a time point with no missing point, the dual-directional AIS data missing value imputation device 100 may perform learning so that the model may make an accurate prediction by reflecting characteristics of the AIS data through an actual value.

The dual-directional AIS data missing value imputation device 100 may utilize a difference between the prediction value and the actual value as a loss for a point in which there is no missing value and an actual value (a correct answer) exists.

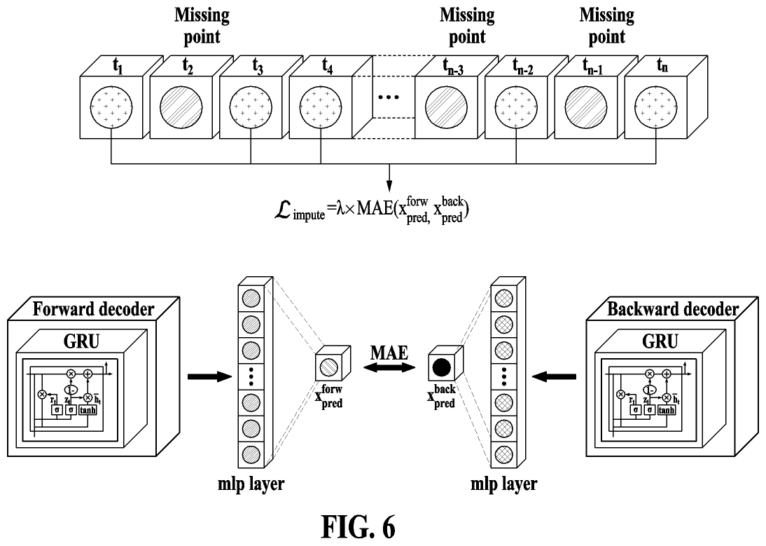

FIG. 6 is a diagram illustrating a loss function used in a prediction of AIS data at a time point having a missing point.

As shown in FIG. 6, since there is no actual value at a point in which a missing value exists, the dual-directional AIS data missing value imputation device 100 may calculate and utilize a loss by satisfying Equation 2, which defines a difference between prediction values of the forward model and the backward model as the loss.

$${ℒ}_{impute} = λ \times MAE ( {x}_{pred ,}^{forw} {x}_{pred}^{back} ) \qquad [ Equation 2 ]$$

In Equation 2, the Limpute denotes a loss at a point in which there is no actual value (in which a missing value occurs), and the λ(lambda) is used as an arbitrary variable and may be set to a value between 0 and 1 to be used to adjust a degree of reflection of the loss.

The dual-directional AIS data missing value imputation device 100 may apply the loss function of Equation 2 so that the prediction values may converge as the forward model and the backward model progress learning from different directions at a time point when there is a missing point.

The dual-directional AIS data missing value imputation device 100 may learn the models so that an error of the prediction value in each direction may be small.

Since there is no actual value (or correct answer) at a point in which a missing value exists, the dual-directional AIS data missing value imputation device 100 may utilize, as losses, a forward prediction value in a forward direction and a backward prediction value in a reverse direction.

The dual-directional AIS data missing value imputation device 100 may apply a concept of semi-supervised learning to an imputation model by learning a loss differently depending on a presence or absence of the actual value without separating data into train/test.

That is, the dual-directional AIS data missing value imputation device 100 may learn the DDDCI model in a semi-supervised learning manner through the loss calculated through Equations 1 and 2.

The dual-directional AIS data missing value imputation device 100 may perform learning in a semi-supervised learning manner, thereby partially utilizing actual values for a time point with no missing values and utilizing prediction values in each direction for a time point with missing values.

According to the present disclosure, it is possible to perform missing value imputation that has an independent characteristic (e.g., learning weights different for each ship) according to each individual ship (MMSI) and higher accuracy than conventional methods.

In addition, according to the present disclosure, by learning movement characteristics of a ship and performing a prediction for a missing value, missing value imputation performance suitable for AIS data may be achieved.

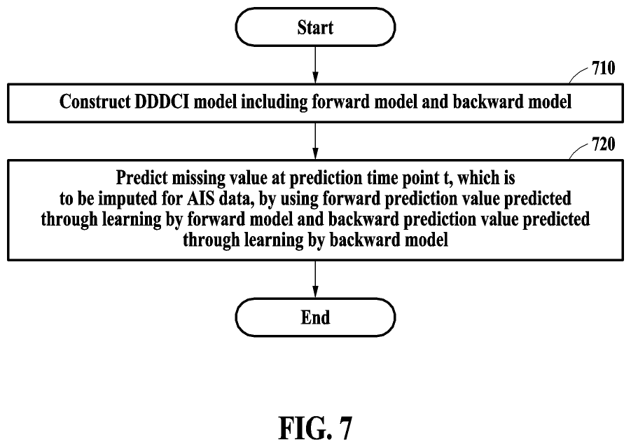

Hereinafter, a work flow of the deep learning-based dual-directional AIS data missing value imputation device 100 is described in detail with reference to FIG. 7.

FIG. 7 is a flowchart illustrating a method of imputing missing values in dual-directional AIS data based on deep learning, according to an embodiment.

The method of imputing missing values in dual-directional AIS data based on deep learning according to the present disclosure may be performed by the deep learning-based dual-directional AIS data missing value imputation device 100.

First, the dual-directional AIS data missing value imputation device 100 may construct a DDDCI model including a forward model and a backward model in operation 710. Operation 710 may be a process of constructing a DDDCI model having a pair of a forward model that learns a trend in a forward direction and a backward model that learns a trend in a reverse direction, wherein the trend is of AIS data at a time point to perform a prediction.

When constructing the DDDCI model, the dual-directional AIS data missing value imputation device 100 may be manufactured to have a structure including a forward model and a backward model, each of which including an encoder and a decoder.

Specifically, the dual-directional AIS data missing value imputation device 100 may construct the forward model that includes an encoder including at least N GRUs and a decoder disposed on a rear end of the encoder and including one GRU.

Here, N may be a number of pieces of second AIS data collected at a time point prior to a prediction time point t and selected to participate in learning.

That is, the dual-directional AIS data missing value imputation device 100 may construct the forward model by including an encoder which includes at least N GRUs for training by inputting N pieces of second AIS data up to t-N prior to the time point t to perform a prediction and a decoder which includes 1 GRU for training by inputting an output value of the encoder.

Here, the GRU is one of RNN techniques and may be a simplified model of LSTM.

For example, the dual-directional AIS data missing value imputation device 100 may configure the encoder by selecting four time points (e.g., t−4, t−3, t−2, and t−1) prior to the prediction time point t and including at least four GRUs that receive, as an input, each of the second AIS data collected through an AIS collection device at the four selected time points (e.g., t−4, t−3, t−2, and t−1). Alternatively, the dual-directional AIS data missing value imputation device 100 may configure an encoder including multiple GRUs and activate only four GRUs, according to the number of the selected time points, among the multiple GRUs.

In addition, the dual-directional AIS data missing value imputation device 100 may configure the decoder including one GRU that receives, as an input, an output value of the encoder and first AIS data (which may have a missing point) collected at t.

In summary, when constructing the forward model, the dual-directional AIS data missing value imputation device 100 may construct the forward model that includes the encoder including at least N GRUs, wherein the N may be the number of pieces of the second AIS data that are input, and the decoder including 1 GRU.

In addition, the dual-directional AIS data missing value imputation device 100 may construct the backward model, which includes a decoder including one GRU and an encoder disposed on a front end of the decoder and including at least N GRUs.

Here, N may be a number of pieces of second AIS data collected at a time point subsequent to the prediction time point t and selected to participate in learning.

That is, the dual-directional AIS data missing value imputation device 100 may construct the backward model by including an encoder which includes at least N GRUs for training by inputting N pieces of the second AIS data up to a time point t+N prior to the time point t to perform a prediction and a decoder which includes 1 GRU for training by inputting an output value of the encoder.

For example, the dual-directional AIS data missing value imputation device 100 may configure the encoder by selecting four time points (e.g., t+1, t+2, t+3, and t+4) subsequent to the prediction time point t and including at least four GRUs that receive, as an input, each of the second AIS data collected through the AIS collection device at the four selected time points (e.g., t+1, t+2, t+3, and t+4). Alternatively, the dual-directional AIS data missing value imputation device 100 may configure an encoder including multiple GRUs and activate only four GRUs, according to the number of the selected time points, among the multiple GRUs.

In addition, the dual-directional AIS data missing value imputation device 100 may configure the decoder including one GRU that receives, as an input, the output value of the encoder and the first AIS data (which may have a missing point) collected at t.

In summary, when constructing the backward model, the dual-directional AIS data missing value imputation device 100 may construct the backward model that includes the decoder including one GRU and the encoder including at least N GRUs, wherein the N may be the number of pieces of the second AIS data that are input.

In addition, in operation 720, the dual-directional AIS data missing value imputation device 100 may predict a missing value at the prediction time point t, which is to be imputed for the AIS data, by using a forward prediction value predicted through learning by the forward model and a backward prediction value predicted through learning by the backward model. Operation 720 may be a process of obtaining the forward prediction value according to forward trend learning from the forward model and the backward prediction value according to backward trend learning from the backward model, and predicting AIS data at a prediction time point t to perform a prediction by considering the forward prediction value and the backward prediction value.

When outputting the forward prediction value and the backward prediction value, the dual-directional AIS data missing value imputation device 100 may utilize a context vector output from the encoder.

To this end, the dual-directional AIS data missing value imputation device 100 may input, to each of the N GRUs in the encoder of the forward model, second AIS data collected at N time points prior to the prediction time point t and perform deep learning to output a context vector from the encoder, and may input, to the decoder, the context vector and first AIS data collected at the prediction time t and perform deep learning to output the forward prediction value from the decoder.

In the above example, the dual-directional AIS data missing value imputation device 100 may input, to each of the four GRUs in the encoder of the forward model, each of the second AIS data collected at four time points (e.g., t−4, t−3, t−2, and t−1) prior to the prediction time point t, so that deep learning may be performed in the four GRUs.

Thereafter, when the context vector is output as a result of deep learning in the encoder, the dual-directional AIS data missing value imputation device 100 may input the context vector and the first AIS data collected at the prediction time t to the decoder of the forward model, so that deep learning may be performed in one GRU, and consequently, the forward prediction value may be output from the decoder.

In addition, the dual-directional AIS data missing value imputation device 100 may input, to each of the N GRUs in the encoder of the backward model, second AIS data collected at N time points subsequent to the prediction time point t and perform deep learning to output a context vector from the encoder, and may input, to the decoder, the context vector and first AIS data collected at the prediction time point t and perform deep learning to output the backward prediction value from the decoder.

In the above example, the dual-directional AIS data missing value imputation device 100 may input, to each of the four GRUs in the encoder of the backward model, each of the second AIS data collected at four time points (e.g., t+1, t+2, t+3, and t+4) subsequent to the prediction time point t, so that deep learning may be performed in the four GRUs.

Thereafter, when the context vector is output as a result of deep learning in the encoder, the dual-directional AIS data missing value imputation device 100 may input the context vector and the first AIS data collected at the prediction time t to the decoder of the backward model, so that deep learning may be performed in one GRU, and consequently, the backward prediction value may be output from the decoder.

In particular, the dual-directional AIS data missing value imputation device 100 may output the context vector through deep learning that reflects a deep learning result derived from a preceding GRU by cascading the deep learning results between the N GRUs. That is, the dual-directional AIS data missing value imputation device 100 may induce the context vector output from the encoder to be closer to a more accurate prediction value by training the GRUs in a cascade manner, in which a deep learning result from a GRU disposed at the front is reflected in a GRU disposed at the back to perform deep learning.

The dual-directional AIS data missing value imputation device 100 may recognize which data column is relatively emphasized and deep-learned in a corresponding GRU by calculating an attention score for each GRU.

That is, the dual-directional AIS data missing value imputation device 100 may produce an attention score that gives a relatively high score to a data column in the second AIS data that has been emphasized and deep-learned during deep learning in the GRU of the encoder.

Here, the data column may be data of the AIS data, in which a missing point mainly occurs, and in the present disclosure, the data column may exemplify a latitude (lat) and a longitude (lon), which are location information of a ship, and a speed (speed over ground, SOG) and a direction (course over ground, COG), which are information on a movement of a ship.

The dual-directional AIS data missing value imputation device 100 may calculate an attention score so that a data column (e.g., lat, lon, SOG, and COG) in the AIS data that was emphasized at each time point during deep learning in a GRU of the encoder may be recognized.

For example, the dual-directional AIS data missing value imputation device 100 may calculate the attention score for the GRU of the encoder, which may receive AIS data at a time point t+1 and perform deep learning, to be relatively high in the SOG item, so that it may be recognizable that the SOG has been emphasized and deep-learned during deep learning in the GRU at the time point t+1.

According to an embodiment, the dual-directional AIS data missing value imputation device 100 may define a loss of a DDDCI model by satisfying a function that is applied differently depending on whether the first AIS data collected at the prediction time point t includes a missing point.

First, when there is no missing point in the first AIS data, the dual-directional AIS data missing value imputation device 100 may define the loss of the DDDCI model by using a difference between the predicted AIS data and actually measured first AIS data and may reflect the defined loss in the forward model and the backward model, thereby increasing an accuracy of the predicted value.

Specifically, the dual-directional AIS data missing value imputation device 100 may determine whether there is a missing point in first AIS data collected at the prediction time point t.

For example, for AIS data including data columns (e.g., lat, lon, SOG, COG, cos_COG, and sin_COG), the dual-directional AIS data missing value imputation device 100 may determine whether there is any missing value in the data columns.

When there is no missing point according to a result of the determination, the dual-directional AIS data missing value imputation device 100 may define a loss of the DDDCI model by satisfying Equation 1, which calculates a difference between an actual value (label) of an actual value (or label) of the first AIS data and each of the forward prediction value and the backward prediction value through MAE.

$${ℒ}_{real} = MAE ( {x}_{pred ,}^{forw} {x}_{real} ) + MAE ( {x}_{pred ,}^{back} {x}_{real} ) \qquad [ Equation 1 ]$$

For a loss at a time point with no missing point, the dual-directional AIS data missing value imputation device 100 may perform learning so that the model may make an accurate prediction by reflecting characteristics of the AIS data through an actual value.

On the other hand, when there is a missing point in the first AIS data collected at the prediction time t, the dual-directional AIS data missing value imputation device 100 may define a loss for imputing the missing point of the first AIS data through the predicted AIS data.

Specifically, when there is a missing point according to a result of the determination, there may be no actual value (or label) of the first AIS data, and thus, the dual-directional AIS data missing value imputation device 100 may define a loss of the DDDCI model by satisfying Equation 2, which calculates only a difference between the forward prediction value and the backward prediction value through MAE.

$${ℒ}_{impute} = λ \times MAE ( {x}_{pred ,}^{forw} {x}_{pred}^{back} ) \qquad [ Equation 2 ]$$

The dual-directional AIS data missing value imputation device 100 may learn the model so that an error of the predicted value in each direction may be small, so that the prediction values may converge as the forward model and the backward model progress learning from different directions at a time point when there is a missing point.

According to an embodiment, a method and device for imputing missing values in dual-directional automatic identification system (AIS) data based on deep learning may be provided, which has an independent character (e.g., learning weights different for each ship) according to each individual ship (MMSI) and performs missing value imputation with higher accuracy than conventional methods.

In addition, according to an embodiment of the present disclosure, the method and device may achieve missing value imputation performance suitable for AIS data by learning movement characteristics of a ship and performing a prediction for a missing value.

The methods according to the embodiments may be recorded in non-transitory computer-readable media including program instructions to implement various operations of the embodiments. The media may also include the program instructions, data files, data structures, and the like alone or in combination. The program instructions recorded on the media may be those specially designed and constructed for the purposes of embodiments, or they may be of the kind well-known and available to one of ordinary skill in the computer software arts. Examples of non-transitory computer-readable media include magnetic media such as hard disks, floppy disks, and magnetic tape; optical media such as CD-ROM discs and DVDs; magneto-optical media such as optical discs; and hardware devices that are specially configured to store and perform program instructions, such as read-only memory (ROM), random-access memory (RAM), flash memory, and the like. Examples of program instructions include both machine code, such as those produced by a compiler, and files containing high-level code that may be executed by the computer using an interpreter. The above-described hardware devices may be configured to act as one or more software modules in order to perform the operations of the examples, or vice versa.

The software may include a computer program, a piece of code, an instruction, or one or more combinations thereof, to independently or collectively instruct or configure the processing device to operate as desired. Software and/or data may be embodied permanently or temporarily in any type of machine, component, physical or virtual equipment, computer storage medium or device, or in a propagated signal wave for the purpose of being interpreted by the processing device or providing instructions or data to the processing device. The software may also be distributed over network-coupled computer systems so that the software is stored and executed in a distributed fashion. The software and data may be stored by one or more non-transitory computer-readable recording mediums.

While the embodiments are described with reference to a limited number of drawings, it will be apparent to one of ordinary skill in the art that various alterations and modifications in form and details may be made in these embodiments without departing from the spirit and scope of the claims and their equivalents. For example, suitable results may be achieved if the described techniques are performed in a different order and/or if components in a described system, architecture, device, or circuit are combined in a different manner and/or replaced or substituted by other components or their equivalents.

Therefore, other implementations, other embodiments, and equivalents to the claims are also within the scope of the following claims.

What is claimed is:

1. A method of imputing missing values in dual-directional automatic identification system (AIS) data based on deep learning, the method comprising:
constructing a deep-dual-directional chained imputation (DDDCI) model comprising a forward model and a backward model; and
predicting a missing value at a prediction time point t, which is to be imputed for AIS data, by using a forward prediction value predicted through learning by the forward model and a backward prediction value predicted through learning by the backward model.

2. The method of claim 1, wherein
the constructing of the DDDCI model comprises:
constructing the forward model comprising an encoder comprising at least N gated recurrent units (GRUs) and a decoder disposed on a rear end of the encoder and comprising one GRU; and
constructing the backward model comprising a decoder comprising one GRU and an encoder disposed on a front end of the decoder and comprising at least N GRUs, and
the N is a number of pieces of second AIS data that are collected at a time point prior to or subsequent to the prediction time point t and selected to participate in learning.

3. The method of claim 2, further comprising:
inputting, to each of the N GRUs in the encoder of the forward model, second AIS data collected at N time points prior to the prediction time point t to perform deep learning, and accordingly outputting a context vector from the encoder; and
inputting, to the decoder, the context vector and first AIS data collected at the prediction time point t to perform deep learning, and accordingly outputting the forward prediction value from the decoder.

4. The method of claim 2, further comprising:
inputting, to each of the N GRUs in the encoder of the backward model, second AIS data collected at N time points subsequent to the prediction time t to perform deep learning, and accordingly outputting a context vector from the encoder; and
inputting, to the decoder, the context vector and first AIS data collected at the prediction time t to perform deep learning, and accordingly outputting the backward prediction value from the decoder.

5. The method of claim 3, wherein the outputting of the context vector from the encoder comprises:
outputting the context vector through deep learning that reflects a deep learning result derived from a GRU on a preceding end by cascading deep learning results between the N GRUs.

6. The method of claim 2, further comprising:
calculating an attention score that gives a relatively high score to a data column in the second AIS data that has been emphasized and deep-learned during deep learning in the GRU of the encoder.

7. The method of claim 1, further comprising:
determining whether there is a missing point in first AIS data collected at the prediction time point t; and
when there is no missing point according to a result of the determination, defining a loss of the DDDCI model by satisfying Equation 1,
$${ℒ}_{real} = MAE ( {x}_{pred ,}^{forw} {x}_{real} ) + MAE ( {x}_{pred ,}^{back} {x}_{real} ) , \qquad [ Equation 1 ]$$
wherein Equation 1 calculates a difference between an actual value (or label) of the first AIS data and each of the forward prediction value and the backward prediction value through mean absolute error (MAE).

8. The method of claim 7, further comprising:
when there is a missing point according to a result of the determination, and there is no actual value (or label) of the first AIS data, defining a loss of the DDDCI model by satisfying Equation 2,
$${ℒ}_{impute} = λ \times MAE ( {x}_{pred ,}^{forw} {x}_{pred}^{back} ) , \qquad [ Equation 2 ]$$
wherein Equation 2 calculates only a difference between the forward prediction value and the backward prediction value through MAE.

9. A device for imputing missing values in dual-directional automatic identification system (AIS) data based on deep learning, the device comprising:
a model construction portion configured to construct a deep-dual-directional chained imputation (DDDCI) model comprising a forward model and a backward model; and
a prediction portion configured to predict a missing value at a prediction time point t, which is to be imputed for AIS data, by using a forward prediction value predicted through learning by the forward model and a backward prediction value predicted through learning by the backward model.

10. The device of claim 9, wherein
the model construction portion is configured to:
construct the forward model comprising an encoder comprising at least N gated recurrent units (GRUs) and a decoder disposed on a rear end of the encoder and comprising one GRU; and
construct the backward model comprising a decoder comprising one GRU and an encoder disposed on a front end of the decoder and comprising at least N GRUs, and
the N is a number of pieces of second AIS data that are collected at a time point prior to or subsequent to the prediction time point t and selected to participate in learning.

11. The device of claim 10, further comprising:
a processing portion configured to:
input, to each of the N GRUs in the encoder of the forward model, second AIS data collected at N time points prior to the prediction time point t to perform deep learning, and accordingly output a context vector from the encoder; and
input, to the decoder, the context vector and first AIS data collected at the prediction time point t to perform deep learning, and accordingly output the forward prediction value from the decoder.

12. The device of claim 10, further comprising:
a processing portion configured to:
input, to each of the N GRUs in the encoder of the backward model, second AIS data collected at N time points subsequent to the prediction time t to perform deep learning, and accordingly output a context vector from the encoder; and
input, to the decoder, the context vector and first AIS data collected at the prediction time t to perform deep learning, and accordingly output the backward prediction value from the decoder.

13. The device of claim 11, wherein the processing portion is configured to:
output the context vector through deep learning that reflects a deep learning result derived from a GRU on a preceding end by cascading deep learning results between the N GRUs.

14. The device of claim 10, further comprising:
a processing portion configured to:
calculate an attention score that gives a relatively high score to a data column in the second AIS data that has been emphasized and deep-learned during deep learning in the GRU of the encoder.

15. The device of claim 9, further comprising:
a determination portion configured to determine whether there is a missing point in first AIS data collected at the prediction time point t; and
a processing portion configured to, when there is no missing point according to a result of the determination, define a loss of the DDDCI model by satisfying Equation 1,
$${ℒ}_{real} = MAE ( {x}_{pred ,}^{forw} {x}_{real} ) + MAE ( {x}_{pred ,}^{back} {x}_{real} ) , \qquad [ Equation 1 ]$$
wherein Equation 1 calculates a difference between an actual value (or label) of the first AIS data and each of the forward prediction value and the backward prediction value through mean absolute error (MAE).

16. The device of claim 15, wherein the processing portion is configured to:
when there is a missing point according to a result of the determination, and there is no actual value (or label) of the first AIS data, define a loss of the DDDCI model by satisfying Equation 2,
$${ℒ}_{impute} = λ \times MAE ( {x}_{pred ,}^{forw} {x}_{pred}^{back} ) , \qquad [ Equation 2 ]$$
wherein Equation 2 calculates only a difference between the forward prediction value and the backward prediction value through MAE.

17. A non-transitory computer-readable storage medium storing instructions that, when executed by a processor, cause the processor to perform the method of claim 1.
